(19) United States
(12) Patent Application Publication
(10) Pub. No.: US 2015/0306491 A1
(43) Pub. Date: Oct. 29, 2015

(54) UNIVERSAL LEARNING SYSTEM

(71) Applicant: Bradley University, Peoria, IL (US)

(72) Inventors: Deitra A. Kuester, East Peoria, IL (US); Eric J. Kuester, East Peoria, IL (US)

(21) Appl. No.: 14/792,338

(22) Filed: Jul. 6, 2015

Related U.S. Application Data
(63) Continuation of application No. 12/033,611, filed on Feb. 19, 2008, now abandoned.
(60) Provisional application No. 60/901,785, filed on Feb. 17, 2007.

(51) Int. Cl. A63F 3/00; G09B 3/00; G09B 19/00

(52) U.S. Cl. CPC A63F 3/00261; G09B 19/00; G09B 3/00

(57) ABSTRACT

A universal game board, game board kit and teaching tool method is provided. The game board is versatile, inexpensive, and easy to modify into a number of different configurations. Teachers use the board as a learning tool, which can be adapted for academic, social and/or cultural activities. The game board is designed to be a motivating learning tool that allows students to interact during academic and social skill development, or may be used for drill-and-practice to supplement a curriculum. The universal game board is comprised of a base with a plurality of tabs sized and shaped to form compartments to receive cards. The cards can be arranged and rearranged on in different configurations. Different games are played on the game board depending on the configuration of the cards. A lid is placed on top of the base, tabs and cards to secure the cards in place for the duration of a game.

### CROSS-REFERENCE TO RELATED APPLICATIONS

This application is a continuation of U.S. application Ser. No. 12/033,611 filed Feb. 19, 2008, which claims priority pursuant to 35 U.S.C. 119(e) to U.S. Provisional Patent Application Ser. No. 60/901,785, filed Feb. 17, 2007, the entire disclosures of which are incorporated herein by reference.

### FIELD OF THE INVENTION

The present invention relates generally to teaching tools and teaching games. More specifically, the present invention is concerned with a modifiable game board, a game board kit and a method of teaching different concepts by using the modifiable game board.

### BACKGROUND OF THE INVENTION

Many different kinds of games and game boards are taught in the prior art. Levinson teaches, in U.S. Pat. No. 6,983,937, a dynamic, non-static game board and strategy game where players move pieces through a maze where the maze configuration is changeable during the course of play. Levinson fails to teach a game board where a user may customize the game concepts and game playing surface and allow the players to play any number of different games upon the board.

Messac teaches, in U.S. Pat. No. 6,776,414, a universal game board in the shape of a box (or cube) where game pieces of varying sizes and shapes are secured to the box via peg and holes to form a variety of different playing surfaces. Messac fails to teach a game board where all of the different pieces of the game surface are uniform in size and shape and where a user may customize the game concepts and the playing surface and the user also selects the game to be played thereon.

Stanton teaches, in U.S. Pat. No. 6,736,398, a modular board game apparatus that includes pairs of removably positionable pieces of playing surfaces such that the playing surface can be configured in a number of different configurations of differing shape and size. Stanton fails to teach a game board where a user may customize the game concepts and the game surface as well as the game to be played thereon.

Using games as teaching tools provides several advantages for both teachers and students. One of these advantages includes enhanced student interest and willingness to participate in the game playing. This advantage is even more apparent in situations of students with special needs. The lack of funding and resources of supplements to the curriculum lead to questions of how teachers could (1) improve academic achievement, (2) maintain student motivation in learning academics, (3) increase social acceptance of students with special needs, and (4) improve success of peer interactions during small group work. A game-like apparatus and related methods address these long felt needs. Thus, the invention is directed to a versatile, inexpensive, universal game board. Teachers use the board as a learning tool, which can be adapted for academic, social and/or cultural activities. The game board is designed to be a motivating learning tool that allows students to interact during academic and social skill development, or may be used for drill-and-practice to supplement a curriculum.

The instant ‘game board’ is versatile in that users can easily write their own questions, drill-n-practice items, interactive statements, and the like, via their classroom or laboratory computer using a pre-designed word processing document (e.g., similar to the already existing formats in Microsoft Word for label making). Users print the document on perforated, colored card stock cards, separate them, and drop them into preformed slots of a molded ‘game board’. The universality of the learning tool refers to the adaptability of the verbiage on the cards toward any skill acquisition and allows users freedom to easily design the direction or layout of a game-like learning activity using any of the slots on the board, depending on where and in which slots the cards are placed.

### SUMMARY OF THE INVENTION

An object of the instant invention is to provide a universal game board. Another object of the instant invention is to provide a versatile, inexpensive game board that allows a user to modify the configuration of the game board layout or content in accordance with a game that the user selects to play on the game board. Another object of the instant invention is to provide a universal game board for use as a learning tool, which can be configured for endless different academic, social and/or cultural activities. Another object of the instant invention is to provide a universal game board to be used as a motivating learning tool, to allow learners to interact during academic and social skills development, or to be used for drill practicing as a curriculum supplement. Another object of the instant invention is to provide a method of teaching. Another object of the instant invention is to provide a method of teaching where a user configures a game board layout or content in accordance with a game to teach predetermined concepts. Another object of the instant invention is to provide a universal game board kit.

Objects of the instant invention are accomplished through the use of a universal game board comprising a base. The base includes a plurality of compartments of uniform size and shape to receive a plurality of cards. After the cards have been arranged in a desired configuration in the compartments on the base, the compartments retain the cards in place for the duration of a game. The compartments allow the cards to be arranged and rearranged into a plurality of desirable configurations. In one embodiment the compartments are comprised of a plurality of tabs protruding from the base. In one embodiment, the cards are arranged to lay flat upon the base. In one embodiment, the cards are of uniform size and shape such that they can be interchanged one for another and can be arranged in a plurality of different configurations. In some embodiments, the base comprises a plurality of tabs, sized and shaped such that they temporarily retain each card in place for the duration of a game after the cards have been arranged in one of a plurality of different configurations and allow the cards to be rearranged into a different configuration after a game has been concluded.

In some embodiments, the game board further comprises a lid, wherein the lid is a transparent, smooth surface and rests on top of the base, cards and tabs such that the cards remain in place for the duration of a game. In other embodiments, the game board further comprises grooves sized and shaped to receive the lid. In other embodiments, the lid is fixedly attached to the base with at least one hinge. In some embodiments, the game board further comprises at least one clasp to temporarily secure the lid to the base.

In one preferred embodiment, the tabs of the game board are arranged on the base such that one hundred (100) cards or less can be arranged on the base in a ten (10) by ten (10) grid. In other preferred embodiments, each of a plurality of cards differs from each other in at least one of the following concepts: color, symbols, pictures, letters, words and phrases. In some embodiments, a concept is affixed to each of the plurality of cards. In other embodiments, the concept is inputted into a computer system and affixed to each of the plurality of cards via a printer operably connected to the computer system. In still other embodiments, a plurality of cards are printed on a single sheet of paper, card stock, etc. and are separated after being printed.

Other objects of the instant invention are accomplished through the use of a method of teaching comprising identifying a plurality of concepts to be included in a teaching game; creating a plurality of cards, wherein each of cards comprises at least one of the concepts identified and wherein the cards are of uniform size and shape such that they can be interchanged one for another and can be arranged in a plurality of different configurations; arranging the cards on the base, wherein the cards lay flat and wherein the base comprises a plurality of tabs sized and shaped such that they temporarily retain each card in place for the duration of a game after the cards have been arranged in one of the plurality of different configurations and allow the cards to be rearranged into a different configuration after a game has been concluded; and playing a game on the board in accordance with predetermined rules such that participants are taught the concepts identified and arranged on cards on the base. In a preferred embodiment, at least one of the plurality of concepts is selected from a group consisting of: color, symbols, pictures, letters, words and phrases. In some embodiments, the method further comprises inputting each concept into a computer system and printing out the concepts onto the cards. In other embodiments, the method further comprises printing out a plurality of cards on a single sheet and separating the cards after they have been printed.

In a preferred embodiment, the method further comprises covering the base, cards and tabs with a lid, wherein the lid comprises a transparent, smooth surface and rests on top of the base, cards and tabs such that the cards remain in place for the duration of a game. In some embodiments, the lid is fixedly attached to the base with at least one hinge. In some embodiments, at least one clasp temporarily secures the lid to the base. In some embodiments, the tabs are arranged on the base such that one hundred (100) cards can be arranged on the base in a ten (10) by ten (10) grid.

Other objects of the instant invention are accomplished through the use of a universal game board kit. In a preferred embodiment, the universal game board kit comprises a set of instructions and a universal game board comprising a base and a plurality of cards arranged to lay flat upon the base, wherein the cards are sized and shaped such that they can be interchanged one for another and can be arranged in a plurality of different configurations, and wherein the base comprises a plurality of tabs, sized and shaped such that they temporarily retain each card in place for the duration of a game after the cards have been arranged in one of the plurality of different configurations and allow the cards to be rearranged into a different one of the plurality of different configurations after a game has been concluded. In one embodiment, the universal game board kit further comprises at least one sample set of cards. In another embodiment, the universal game board kit further comprises software comprising a template for printing out customized sets of cards.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a top view of a preferred embodiment of a game board of the instant invention.

FIG. 2 is a front view of the game board of FIG. 1.

FIG. 3 is a cross sectional view of the game board of FIG. 1 taken along the line A-A shown in FIG. 1.

FIG. 4 is detail view of section B of FIG. 3.

FIG. 5 is an isometric view of the game board of FIG. 1.

FIGS. 6-8 show several alternative, non-limiting embodiments of card layouts that may be utilized with the game board of FIG. 1.

FIGS. 9-19 show several alternative, non-limiting embodiments of game cards used to form any of the card layouts of FIGS. 6-8, or any alternative card layouts desired on the game board of FIG. 1.

FIG. 20 is an answer sheet to the questions on the cards of FIGS. 12-13.

FIG. 21 is an answer sheet to the questions of the cards of FIGS. 14-15.

FIG. 22 is an answer sheet to the questions of the cards of FIGS. 16-17.

FIG. 23 is an answer sheet to the questions of the cards of FIGS. 18-19.

### DETAILED DESCRIPTION OF A PREFERRED EMBODIMENT

As required, a detailed embodiment of the present inventions is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

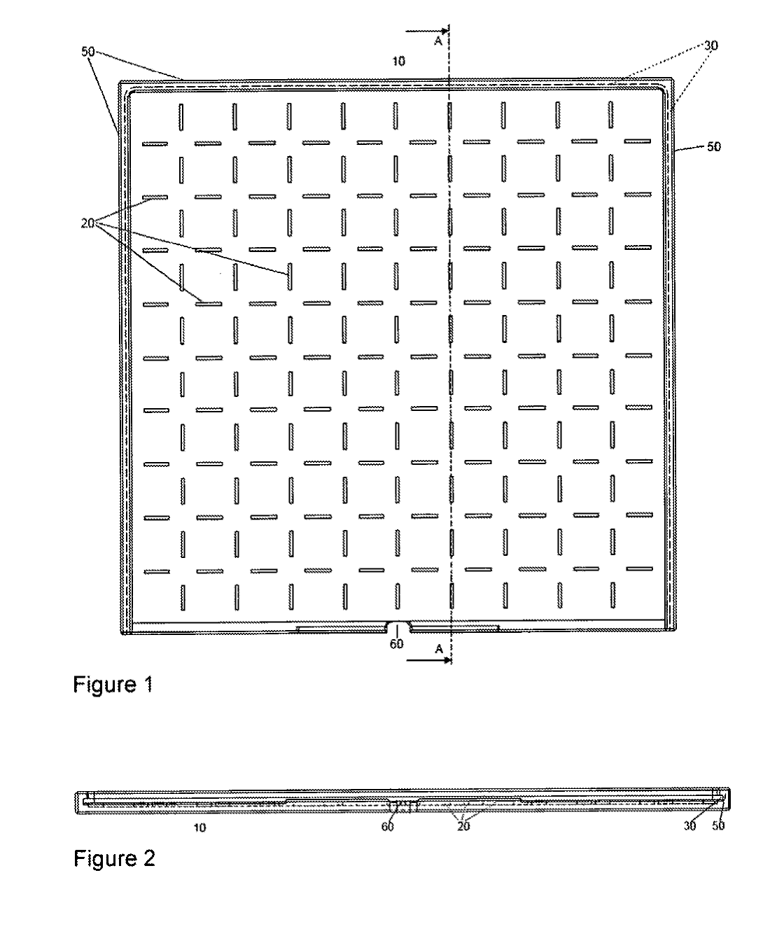

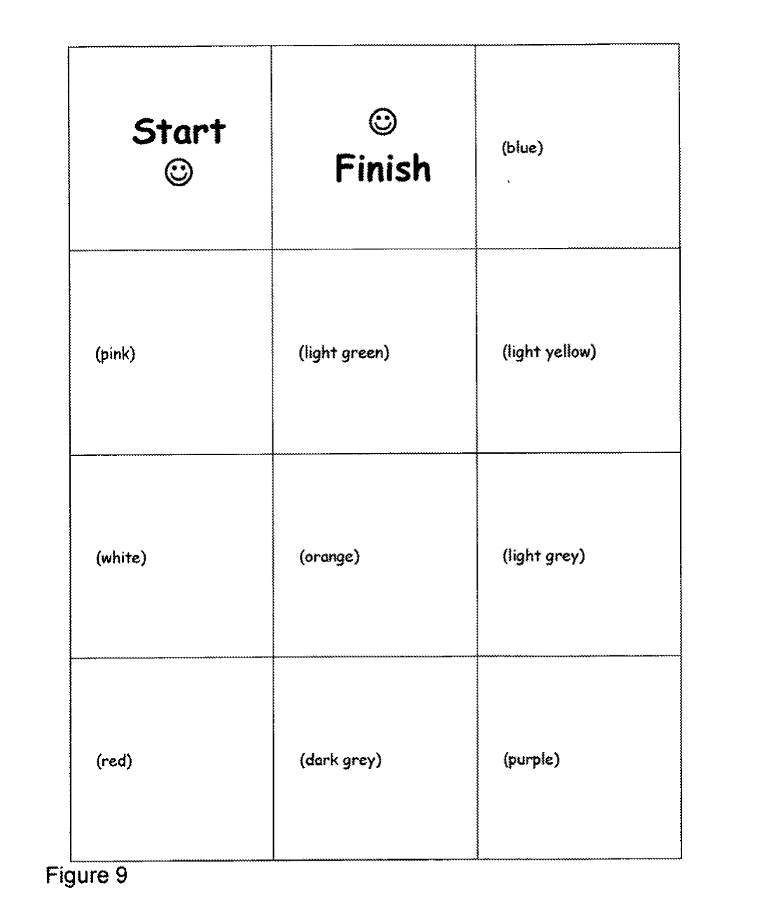

Referring to FIG. 1, a universal game board of a preferred embodiment of the instant invention is shown. FIG. 1 shows a square-shaped universal game board base (10) with a plurality of tabs (20) protruding upward from base (10), sized and shaped such that they temporarily retain cards (not pictured in FIG. 1, but see FIGS. 9-19 for sample cards) in place for the duration of a game after the cards have been arranged in a desired configuration within compartments created by the tabs. The arrangement of the tabs (20) on the base (10) allows the cards to be arranged and/or rearranged into a plurality of different configurations after a game has been concluded. The arrangement of the tabs is not limited to a particular method, means or structure, but non-limiting examples in some configurations include, a 10 by 10 grid, an 8 by 8 grid, and a 10 by 8 grid. The tabs (20) shown in FIG. 1 are arranged on the base (10) such that one hundred (100) cards (or less depending upon the desired configuration) can be arranged on the base (10) in a ten (10) by ten (10) grid. FIG. 1 also shows a plurality of grooves (30) sized and shaped to receive a lid (40), wherein the lid (40) is a transparent, smooth surface panel that rests on top of the base (10), cards (not shown) and tabs (20) such that the cards remain in place for the duration of a game.

As shown in FIG. 1, in a preferred embodiment, the board base (10) is divided into a plurality of square compartments, bordered, at least partially, on each side by a tab (20), such that a card is held in place in each one of the compartments while a game is being played. In the embodiment shown in FIG. 1, the compartments are 1.75 inches on each side and the cards are similarly sized to fit therein. Nevertheless, it will be appreciated that alternative shapes and sizes of compartments may be utilized without departing from the spirit and scope of the instant invention.

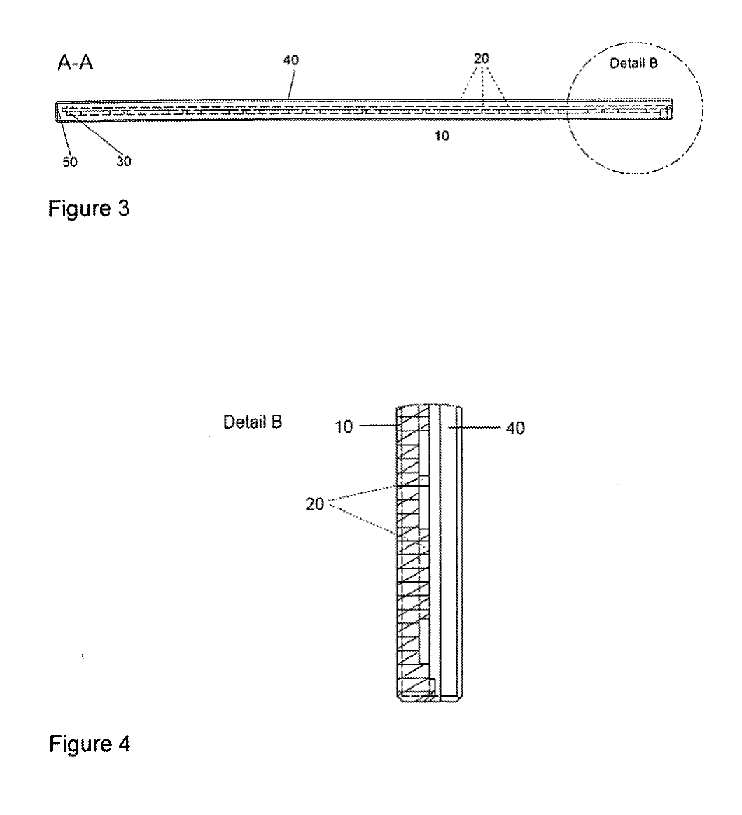

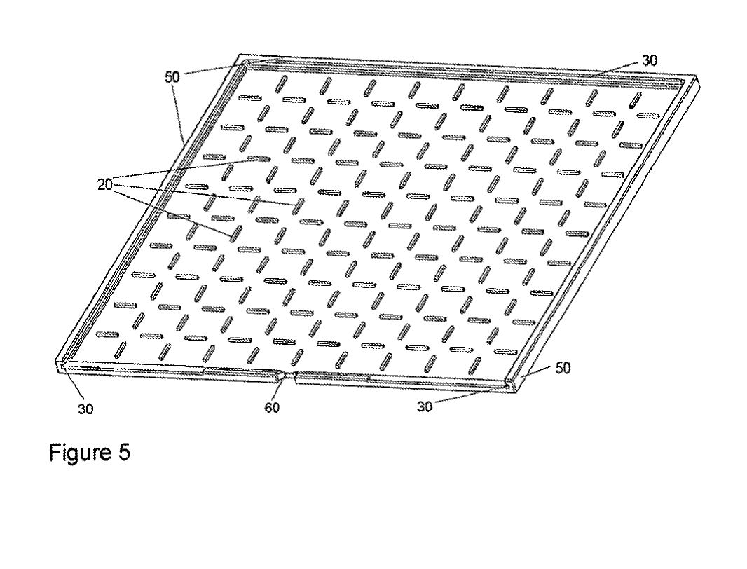

FIG. 2 shows a front view and FIG. 5 shows an isometric view of the game board shown in FIG. 1. Referring to FIG. 3, a cross sectional view of the game board shown in FIG. 1, along the line A-A, is shown. FIG. 3 shows how the transparent, smooth surfaced lid (40) slides into the plurality of grooves (30) and rests on top of the base (10), cards (not shown) and tabs (20) such that the cards remain in place for the duration of a game. Referring to FIG. 4, a detail view of section B of FIG. 3 is shown.

The lid (40) and base (10) of the embodiment shown in FIGS. 1-5 are connected in a tongue and groove manner. The game board includes a wall protruding from along three edges of the base (10). A fourth edge does not include a wall. Each wall includes a groove (30). Each groove (30) is sized and shaped such that an edge of the lid (40) fits therein and slides along the groove in to and out of a position where the lid (40) covers the base (10), tabs (20) and cards. The fourth edge is open such that the lid (40) is inserted into the grooves at the fourth edge and slid into the position where the lid (40) covers the base (10), tabs (20) and cards. The fourth edge also includes a notch in the base (10) such that a user can more easily access and/or grasp the lid (40) for removal. In another embodiment (not shown), the lid (40) is connected to the base (10) with a hinge and clasp.

The material of the base (10) is not limited to a particular method, means or structure, but non-limiting examples in some embodiments include, plastic, metal or wood. The base of the embodiment shown in the figures is made of molded clear plastic.

In one preferred embodiment of the invention, a kit comprises a universal game board and a set of instructions for using the board and/or playing various games on the board. The kit also includes at least one sample academic or social skill game card packet, as an example of game cards, along with blank game cards that allow a user of the kit to create a customized game based upon whatever concepts the user desires.

In one preferred embodiment, a kit contains the following: one universal game board with cover; eight game pieces (four colored pawns and four colored tokens); three dice (one large foam, one standard-sized white and one standard-sized colored); four basic calculators; and four sample game kits. The four sample game kits include: social scenarios; idioms; science; and math. Each of the sample game kits include: 22 blank colored cards; one start card; one finish card; 24 generic “move forward” cards; 24 generic “move back” cards; 50 game question cards; one answer sheet; a set of instructions; one small tablet for keeping score; and sheets displaying example game board layouts.

Referring to FIGS. 9-19, embodiments of some sample game cards are shown. The cards may be any color and may include any content desired. The cards may be arranged with several cards on a single page such that they can be easily and efficiently reproduced. Users may also make their own cards. In a preferred embodiment users make their own cards by using a computer software template, such as a three by four table/grid of two inch by two inch squares in Microsoft Word and printing the table onto sheets of paper or cardstock, then cutting each card out of each of the sheets. It will be appreciated that other methods and devices may be used by users to create their own cards without departing from the spirit and scope of the instant invention.

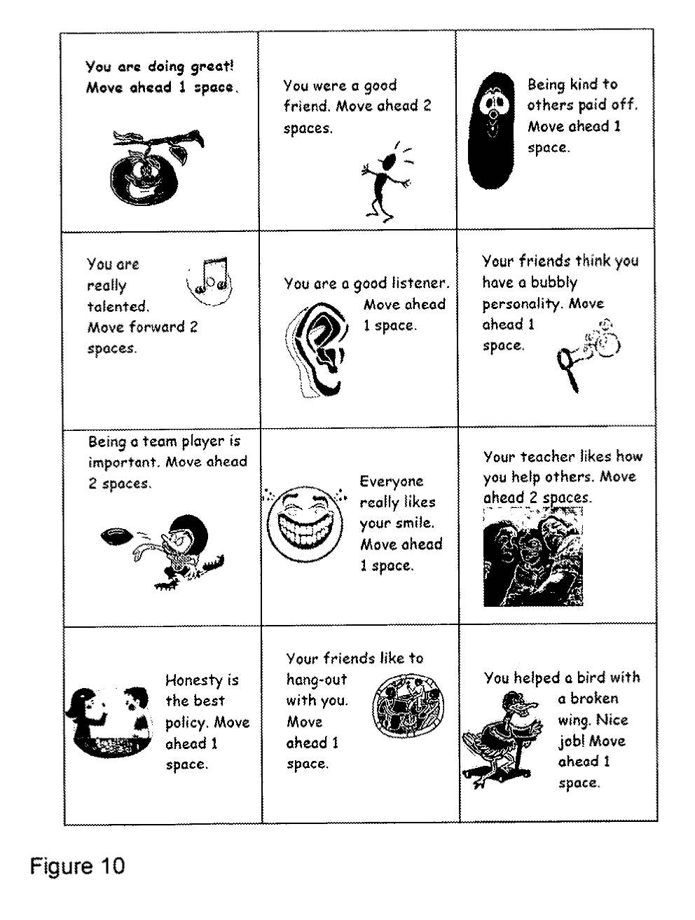

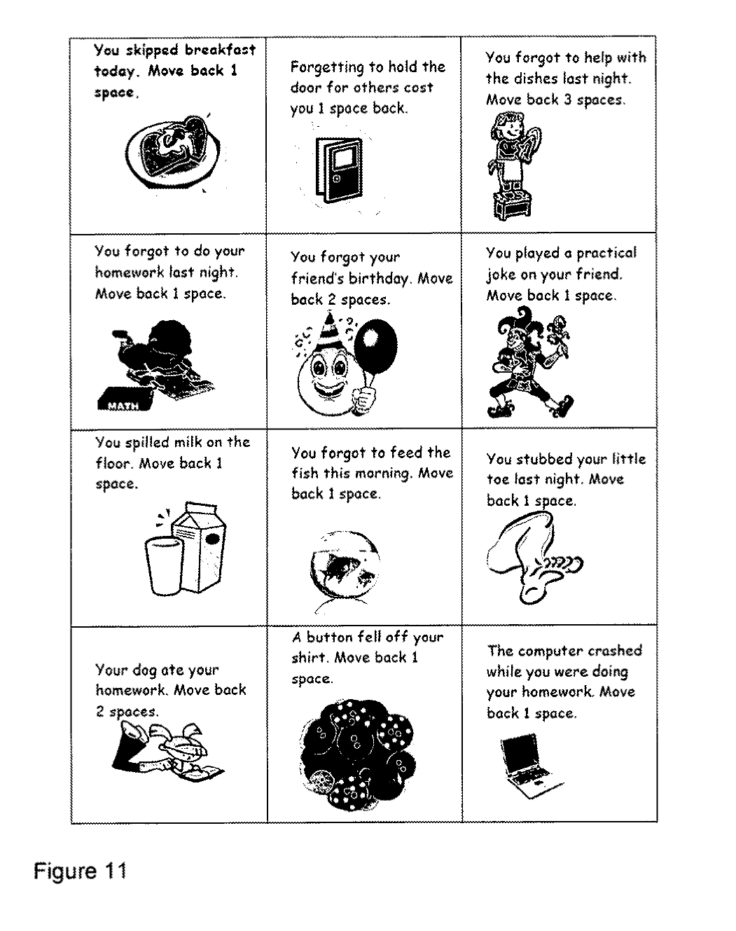

FIG. 9 shows a start card, a finish card, and ten blank cards of various colors (the colors being written in parenthesis on each card shown in FIG. 9). FIG. 10 shows 12 generic “move forward” cards. FIG. 11 shows 12 generic “move back” cards. The start, finish, blank and generic cards may be used in any game and/or configuration. It will be appreciated that other start, finish, blank and/or generic cards may be used for different games without departing from the spirit and scope of the instant invention.

To play a game of this example, the lid (40) of the universal game board is removed to expose the square game board compartments. Game cards are arranged flat upon the game board base (10) and retained in place by surrounding tabs (20). Some sample game cards are shown in FIGS. 9-19. Nevertheless, it will be appreciated that game cards with other graphical content may be utilized without departing from the spirit and scope of the instant invention. After arranging the game cards in a desired configuration, as described below, the lid (40) is slid back in place, along the grooves (30), resting on top of the base (10), tabs (20) and cards, securing the cards in their compartments.

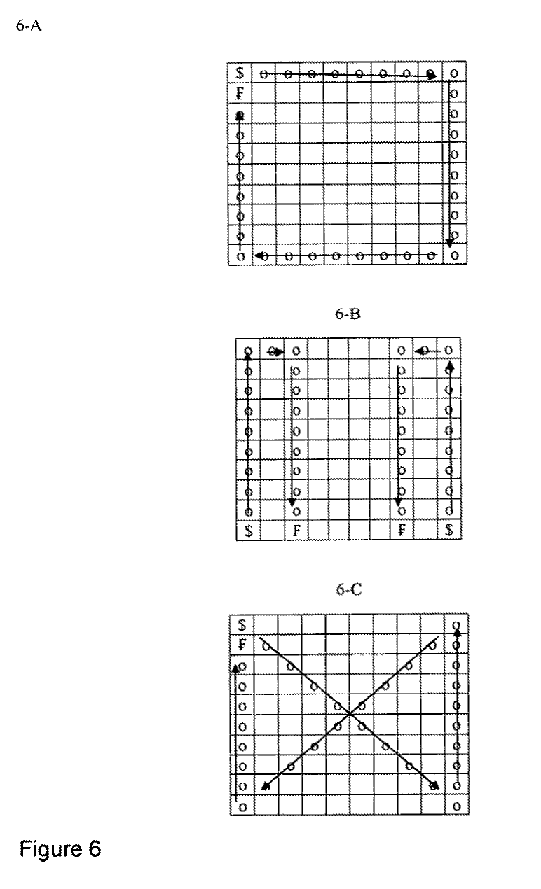

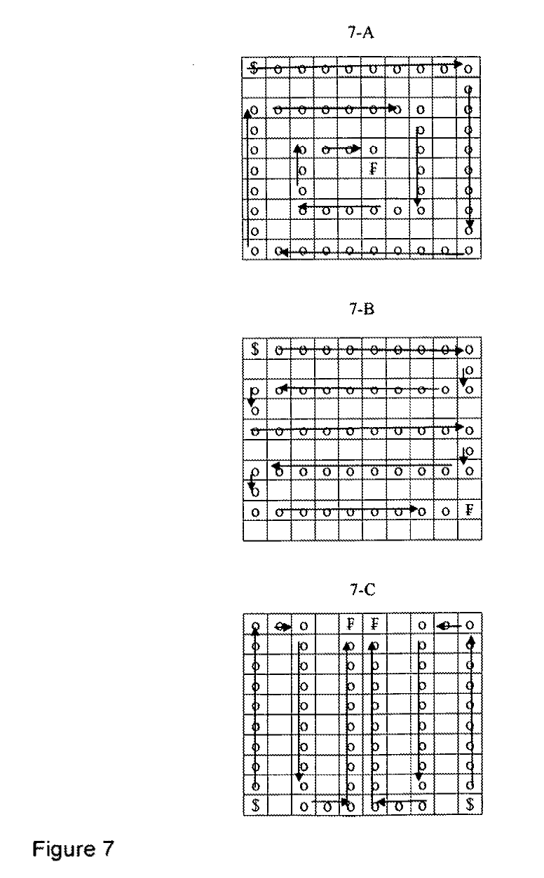

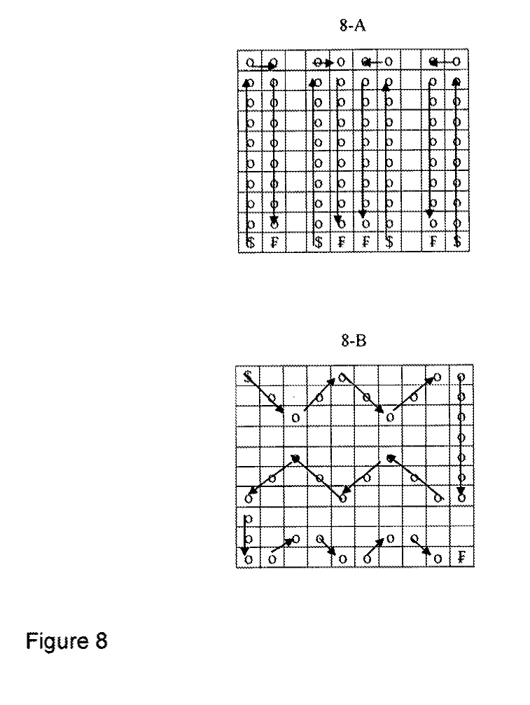

Game cards are arranged upon the game board base (10) according to any of the configurations shown in FIGS. 6-8, or according to any other desired configuration. FIGS. 6, 7 and 8 show sample layouts for the universal game board. FIGS. 6-8 show game piece directional movement. Game pieces begin on the start square, indicated by a ($) sign. Game pieces advance along a path of movement pattern squares, indicated by an (o) sign. Game play advances in the direction of the arrows shown. A game concludes when a player or players reach the finish square, indicated by a (F) sign. FIG. 6-A shows a traditional game layout pattern where game play proceeds in a clockwise manner along the perimeter squares of the game board. FIG. 6-B shows “drag racing” between two players (or two different paths). FIG. 6-C shows a “criss-cross” pattern. FIG. 7-A shows a circular pattern. FIG. 7-B shows a zigzag pattern. FIG. 7-C shows a longer path for “drag racing” between two players (or two different paths). FIG. 8-A shows “drag racing” between four players (or four different paths). FIG. 8-B shows a diagonal pattern. It will be appreciated that game cards may be arranged in other configurations upon the game board without departing from the spirit and scope of the instant invention.

The player(s) determine who goes first by rolling a dice. Players take turns rolling the dice, moving their game piece the indicated number of spaces on the dice, and completing the indicated task (answer the question, move forward/backward, or do nothing). Players use the scratch paper for calculations and for keeping score. Players may check each other's answers by comparing them to an answer sheet. Each player earns one point for each question he or she answers correctly. The player who arrives at the finish space with the most number of points wins.

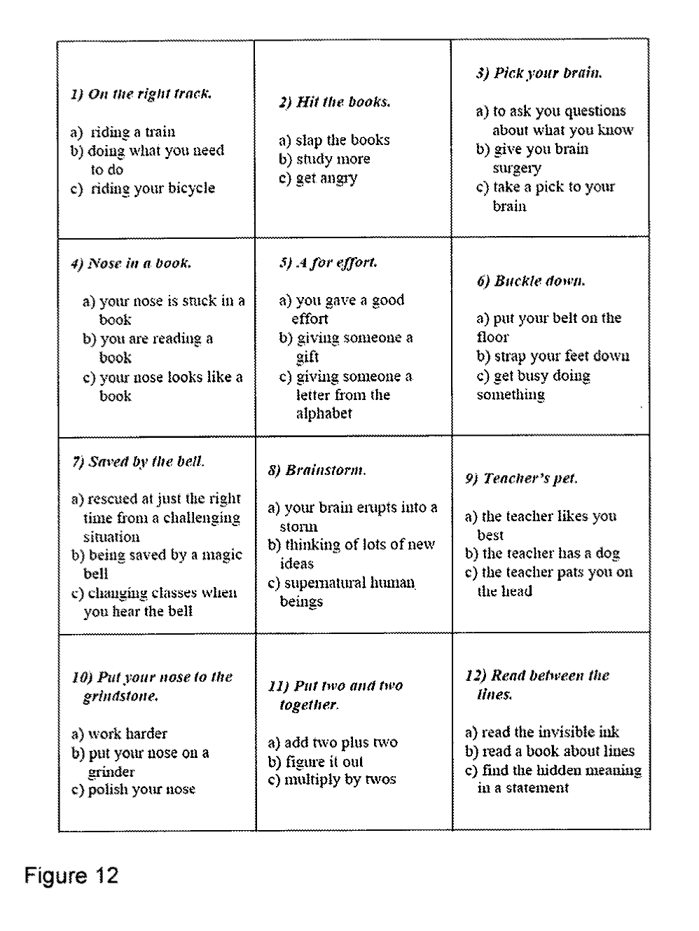

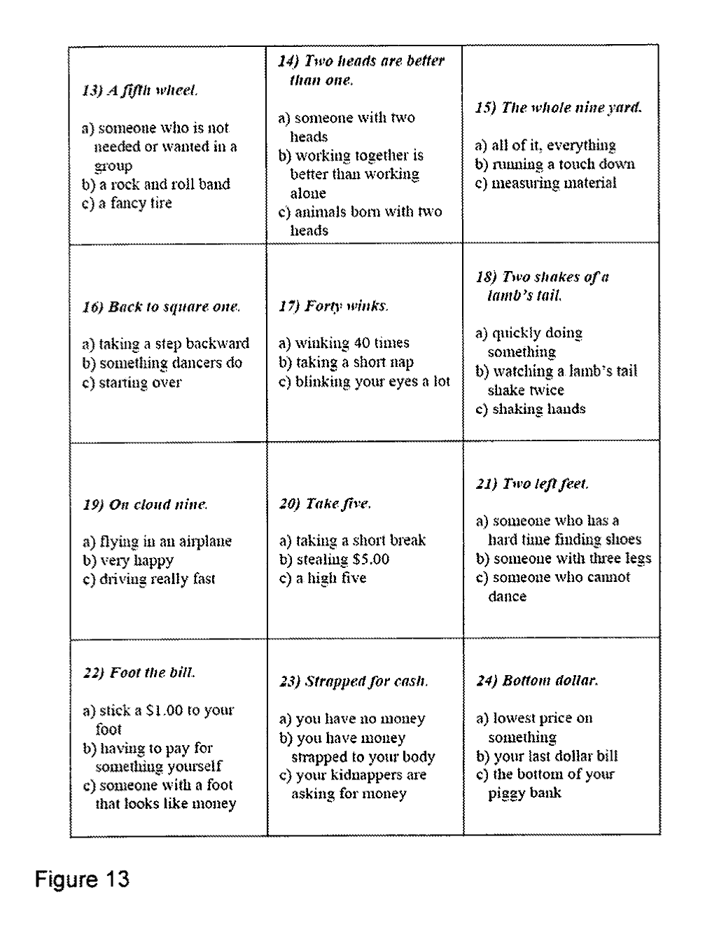

One example of a game played on one embodiment of the instant invention is an Idiom game. The Idiom game is appropriate for all grade levels and especially for all populations with special needs. It is recommended for four or fewer players. Game cards are selected from those shown in FIGS. 12-13. An answer sheet to the questions of FIGS. 12-13 is shown in FIG. 20.

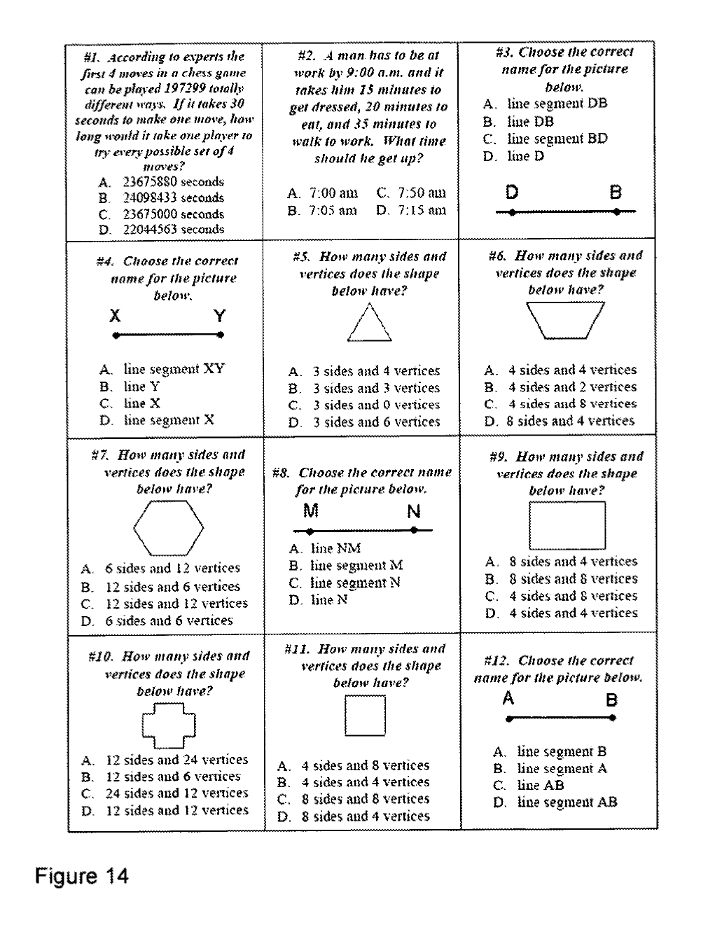

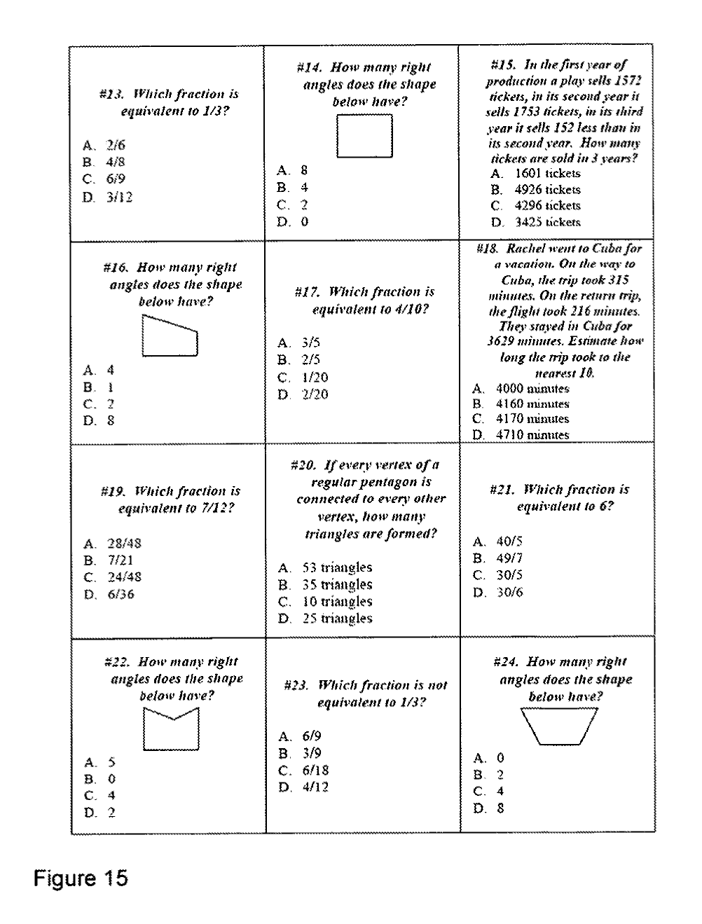

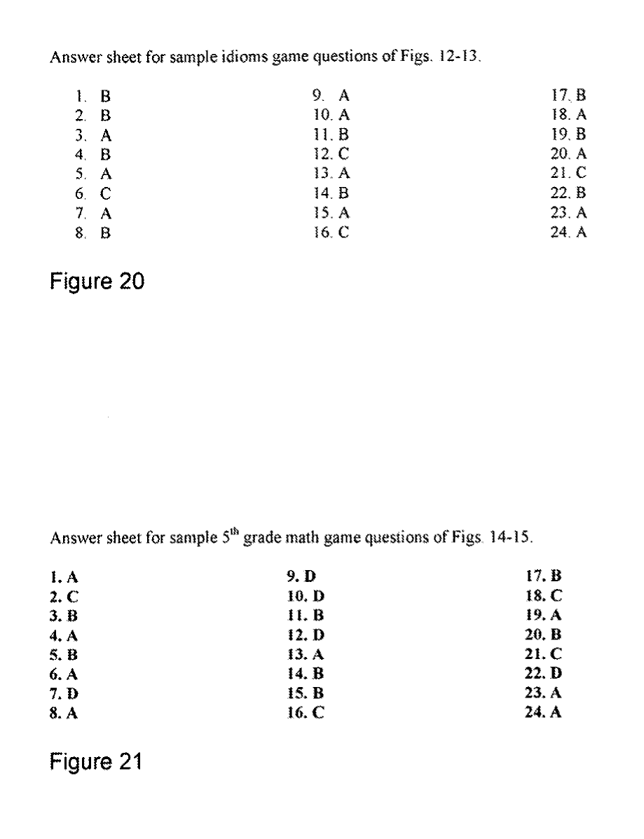

Another example of a game played on one embodiment of the instant invention is a 5^{th} Grade Math game. The Math game is appropriate for 5^{th} grade general curriculum. It is recommended for four or fewer players. Game cards are selected from those shown in FIGS. 14-15. An answer sheet to the questions of FIGS. 14-15 is shown in FIG. 21.

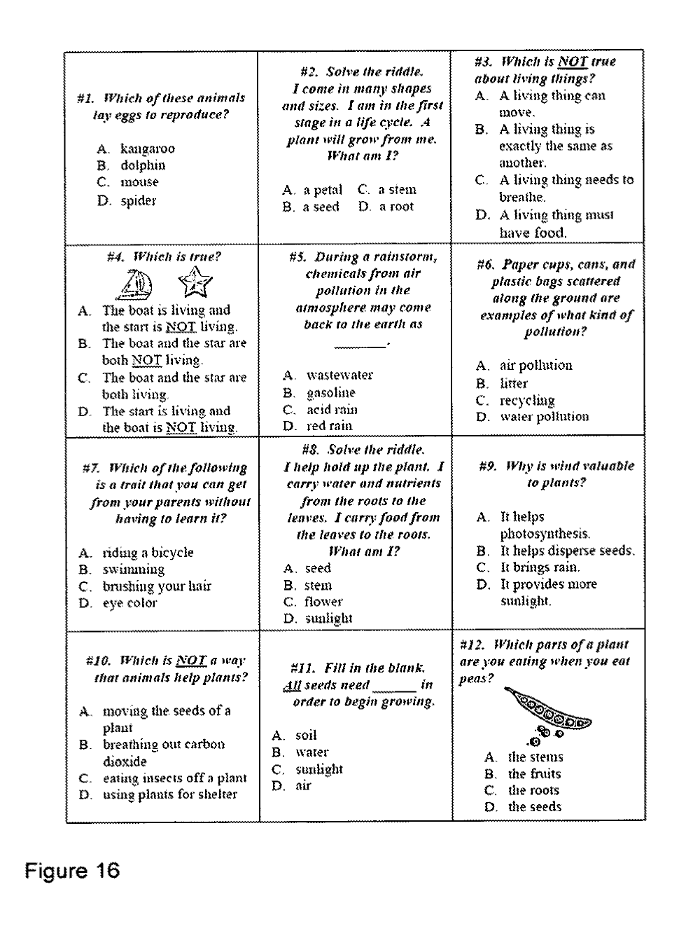

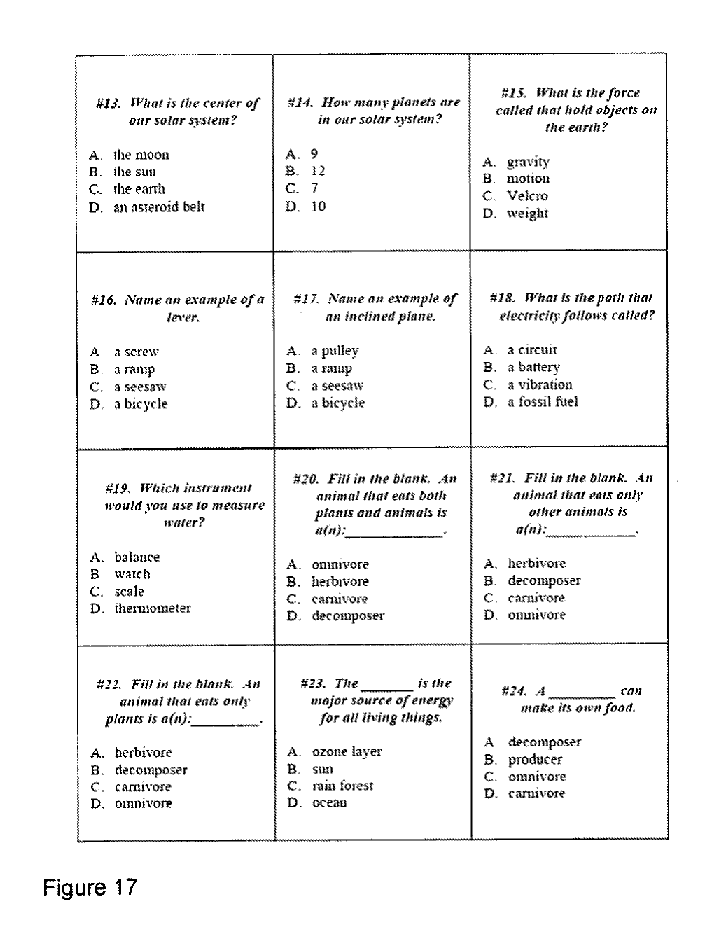

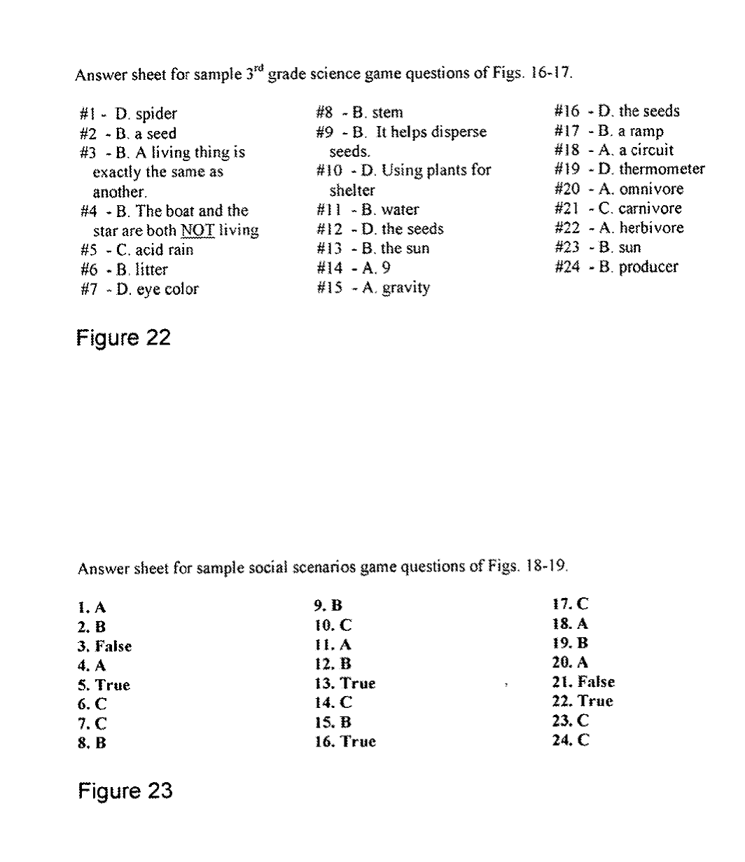

Another example of a game played on one embodiment of the instant invention is a 3^{rd} Grade Science game. The Science game is appropriate for 3^{rd} grade general curriculum. It is recommended for four or fewer players. Game cards are selected from those shown in FIGS. 16-17. An answer sheet to the questions of FIGS. 16-17 is shown in FIG. 22.

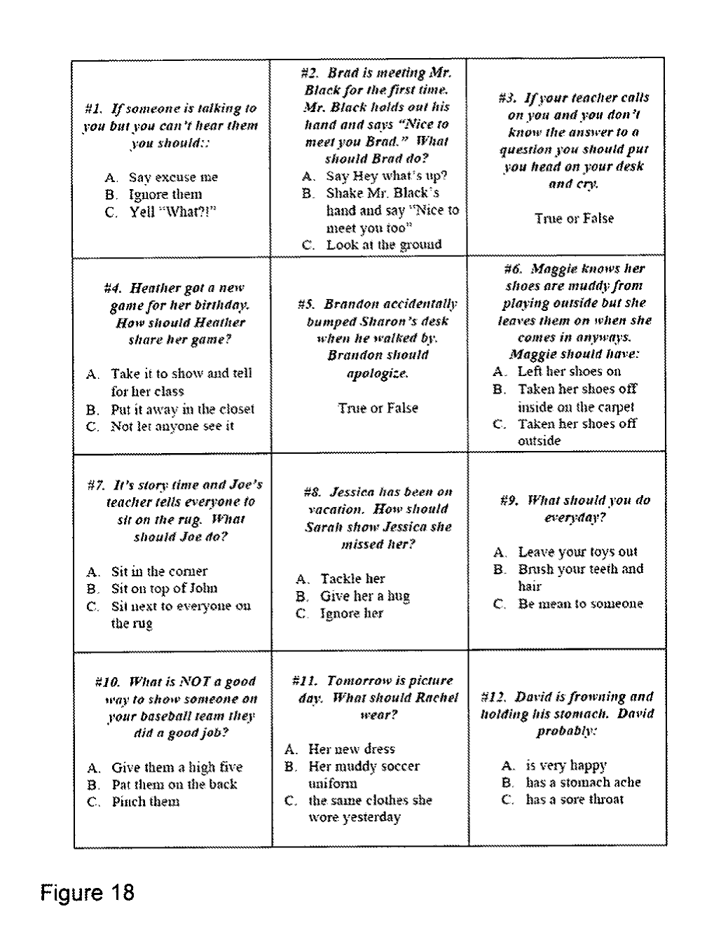

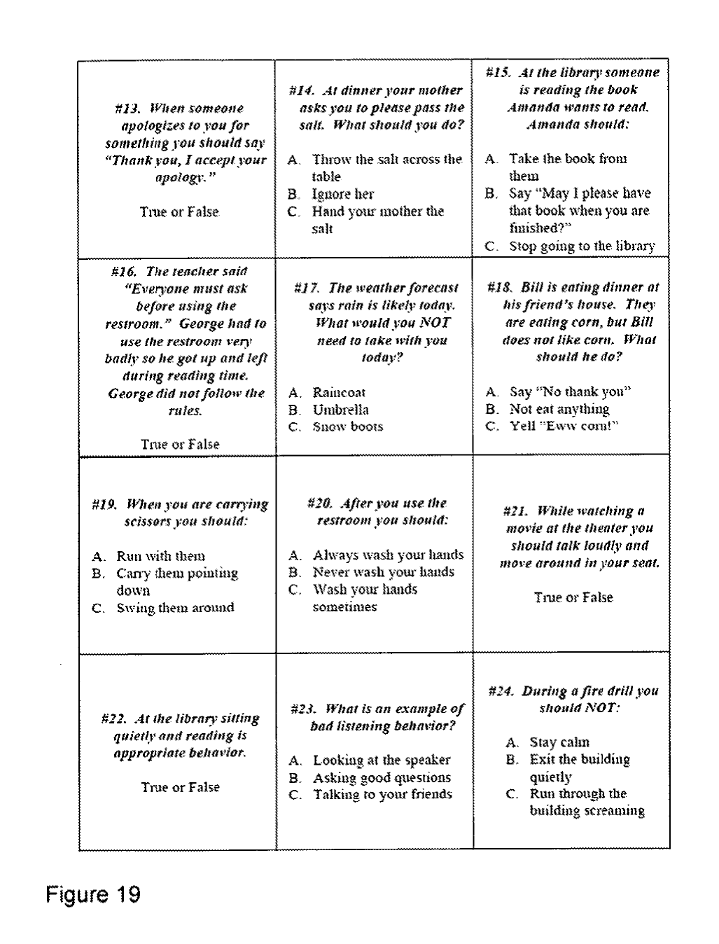

Another example of a game played on one embodiment of the instant invention is a Social Scenarios game. The Social Scenarios game is appropriate for all grade levels and especially for all populations with special needs. It is recommended for four or fewer players. Game cards are selected from those shown in FIGS. 18-19. An answer sheet to the questions of FIGS. 18-19 is shown in FIG. 23.

Advantages of this educational universal game board system afford educators (teachers, parents, mentors, clergy, consultants, therapists, etc.) the ability to customize learning questions that center around any skill acquisition for any grade level, and/or any subject area. Educators have the flexibility in the practice of this invention in designing a variety of game-like learning activities that allow students movement during small group peer interactions. Additionally educators can use the learning tool to improve academic achievement through drill-and-practice activities, decrease planning time thereby increasing one-on-one assistance to lower functioning populations, and improve motivation and social acceptance among students through the use of game-like activities.

Because the educational game system is a game-like format, students are motivated to learn and interact during small groups. Costs are low thus making the game feasible, affordable and more appealing to educators. In addition, minimal instructions are required for educators to fully take advantage of this game, that is because the card layouts can be designed to match already existing software formats in Microsoft Word or other readily available formats.

The game board is versatile. Users write their own questions, drill-n-practice items, interactive statements, etc. These can be hand-written or written electronically via a personal, classroom or laboratory computer using a pre-designed document template (i.e., similar to the already existing formats in Microsoft Word for label making). Users print the document on any available paper, preferably perforated, colored card stock cards. Users separate the cards and arrange them on the base of the board. Users may arrange the cards in any of the layouts shown in FIGS. 6-8, or alternatively, may design their own custom layout to create new games using their custom content/concepts. The tabs hold the cards in place and prevent the cards from becoming dislodged while participants are playing a game on the game board surface.

Some additional embodiments include:

21. The universal game board kit as claimed in claim 16, further comprising a plurality of blank cards, wherein a different concept is selected for each of said blank cards, wherein said concept is selected from a group consisting of: color, symbols, pictures, letters, words and phrases.
22. The universal game board kit as claimed in claim 21, wherein each concept is inputted into a computer system and printed onto said blank cards.
23. The method as claimed in claim 10, wherein at least one of said plurality of cards arranged on said base to indicate a path of movement includes information that directly affects game play.
24. The method as claimed in claim 10, wherein at least one of said plurality of cards arranged on said base to indicate a path of movement includes one of a start card, a finish card, a generic “move forward” card, a generic “move back” card, a blank color card, or a question card.
25. The universal game board as claimed in claim 1, wherein at least one of said plurality of cards arranged on said base to indicate a path of movement includes information that directly affects game play.
26. The universal game board as claimed in claim 1, wherein at least one of said plurality of cards arranged on said base to indicate a path of movement includes one of a start card, a finish card, a generic “move forward” card, a generic “move back” card, a blank color card, or a question card.
27. The universal game board kit as claimed in claim 16, wherein at least one of said plurality of cards arranged on said base to indicate a path of movement includes information that directly affects game play.
28. The universal game board kit as claimed in claim 16, wherein at least one of said plurality of cards arranged on said base to indicate a path of movement includes one of a start card, a finish card, a generic “move forward” card, a generic “move back” card, a blank color card, or a question card.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A universal game board comprising:
a base;
wherein said base comprises a plurality of compartments of uniform size and shape for receiving and temporarily retaining a plurality of cards, the compartments being disposed such that cards can be arranged in a plurality of configurations to indicate different paths of movement for a game piece; and
a lid comprising a transparent smooth surfaced panel that cooperates with the base such that the panel rests on top of cards received by the respective compartments so that the cards remain in place for the duration of a game.

2. The universal game board as claimed in claim 1 wherein said compartments comprise tabs protruding from said base.

3. The universal game board as claimed in claim 1 wherein said compartments allow the cards to be rearranged into a different configuration after a game has been concluded.

4. The universal game board as claimed in claim 1, wherein said base further comprises a groove sized and shaped to receive said lid.

5. The universal game board as claimed in claim 1, wherein said base further comprises:
four edges;
a wall protruding from three of said edges; and
each wall comprises a groove sized and shaped to receive said lid.

6. The universal game board as claimed in claim 5, wherein said base further comprises a notch in said fourth edge.

7. The universal game board as claimed in claim 1, wherein said lid is fixedly attached to said base with at least one hinge.

8. The universal game board as claimed in claim 1, further comprising at least one clasp to temporarily secure said lid to said base.

9. The universal game board as claimed in claim 2, wherein said tabs are arranged on said base to provide a ten (10) by ten (10) grid of 100 compartments for receiving cards.

10. A method of assembling a universal game board in accordance with claim 1, the method comprising:
arranging a plurality of cards on the base of the universal game board to indicate a path of movement for a game piece, each card being received by a respective compartment; and
covering said cards with a lid comprising a transparent smooth surfaced panel such that the panel rests on top of said cards so that said cards remain in place for the duration of a game.

11. The method as claimed in claim 10, wherein at least one of the cards indicates a start, and at least one of the cards indicates a finish.

12. The method as claimed in claim 10 further comprising the step of rearranging said cards into a different configuration after the game has been concluded.

13. The method of claim 10, further comprising the step of selecting a different concept of each of said cards.

14. The method of claim 13 wherein said concept for at least one of said cards is selected from a group consisting of: color, symbols, pictures, letters, words and phrases.

15. The method of claim 13, further comprising:
inputting each concept into a computer system and printing out the concepts onto the cards.

16. A universal game board kit comprising:
at least one sample set of cards; and
a universal game board as claimed in claim 1.

17. The universal game board kit as claimed in claim 16, wherein at least one of the cards indicates a start and at least one of the cards indicates a finish.

18. The universal game board kit as claimed in claim 16, further comprising:
a set of instructions.

19. The universal game board kit as claimed in claim 16, further comprising:
software comprising a template for printing out customized sets of cards.

20. The universal game board kit as claimed in claim 16, wherein each of said cards differs from at least one other in at least one of the following concepts: color, symbols, pictures, letters, words and phrases.
